(19) United States
(12) Patent Application Publication
(10) Pub. No.: US 2015/0092887 A1
(43) Pub. Date: Apr. 2, 2015

(54) Compact antenna-transmitter system

(71) Applicant: Richard Strnad, Plano, TX (US)

(72) Inventor: Richard Strnad, Plano, TX (US)

(21) Appl. No.: 14/041,272

(22) Filed: Sep. 30, 2013

(51) Int. Cl. H04L 27/04

(52) U.S. Cl. CPC H04L 27/04
USPC 375/300

(57) ABSTRACT

A transmission system includes two sections. First transmitter section, located some distance from antenna, generates low power RF signal, which may be converted to digital format, modified for digital signal transport to second section transmitter, or it may transport low power RF analog signal to second section transmitter. The second section transmitter accepts signal from the first part transmitter. The incoming signal may be either pre-amplified for RF power amplifier, or if the imported signal is in the digital form it is converted into analog signal and pre-amplified for RF power amplifier. After final RF power amplification in the second section of the RF transmitter, the signal is transmitted directly to antenna radiating elements without transmission line.

### FIELD OF THE INVENTION

The invention relates generally to a compact antenna-transmitter system that is utilizing direct connection of transmitter power amplifier to antenna conductors without the standard high power transmission line.

### BACKGROUND

A radio frequency (RF) transmitter consists of several elements. These elements depend on the purpose of transmission, such as operating frequency, stability, signal purity, type of modulation, efficiency and level of output power. With higher power transmission, factors such as radiation safety and protection from high voltages are considered.

FIG. 1 illustrates a conventional transmitter station 100. It consists of a transmitter 110, standing wave ratio (SWR) meter 115, transmission line 120, antenna supporting tower 125 and an antenna radiator 130.

Typically a simple transmitter design 400 as illustrated in FIG. 4 includes a carrier oscillator 415, a balanced modulator 425, an SSB filter 430, a preamplifier 435, and a power amplifier 440. For a fixed frequency transmitter a resonant quartz crystal 420 is used in a crystal oscillator to fix the frequency. Where the frequency has to be variable, several options can be incorporated. These include an array of crystals used to enable a transmitter to be used on several different frequencies, or a system is used with variable-frequency oscillator (VFO), phase-locked loop frequency synthesizer or direct digital synthesis.

In many cases, the carrier wave is mixed with another electrical signal, such as an audio signal 405 with preamplifier 410, to impose information upon it. This occurs in amplitude modulation (AM). In amplitude modulation, the instantaneous change in the amplitude of the carrier frequency is with respect to the amplitude of the modulating or base band signal. The output of this stage is then amplified using a linear RF amplifier.

Several derivatives of AM are in common use. These are single-sideband modulation SSB, or SSB-AM single-sideband full carrier modulation, which is similar to single-sideband suppressed carrier modulation (SSB-SC). A filter method is a common technique to generate the SSB signal. Using a balanced mixer, a double side band signal is generated, which is then passed through a very narrow bandpass filter to leave only one side-band, eliminating the other sideband.

After the RF signal (CW, AM, SSB) is processed, it is amplified. RF power in excess of 2 kW utilizes less expensive electron tubes; however for low and medium power, it is often the case that solid state power stages are used.

Linking the transmitter to the antenna is a challenge during the design. The majority of modern transmitting equipment is designed to operate with a resistive load transmitted via coaxial cable 445 of particular characteristic impedance, often 50 ohms. To connect the antenna to this coaxial cable transmission line, a matching network and/or a balun may be required. Commonly, an SWR meter and/or an antenna analyzer are used to check the extent of the match between the aerial system and the transmitter via the transmission line (feeder). An SWR meter indicates forward power, reflected power, and the ratio between them.

Harmonics are unwanted signals which are usually multiples of the operation frequency of the transmitter. They can be generated in a stage of the transmitter even if it is driven with a perfect sine wave because no real life amplifier is perfectly linear. It is best if these harmonics are designed out at an early stage. In addition to the good design of the amplifier stages, the transmitter's output should be filtered with a low pass filter to reduce the level of the harmonics.

FIG. 1 (PRIOR ART) (100) includes a conventional transmitter (110), SWR meter (115), transmission line (120) delivering RF power from transmitter (110) to antenna (130) suspended on tower (125).

FIG. 4 (PRIOR ART) shows a simple version of an SSB analog audio RF transmitter 400. Analog signal, produced by microphone 405, is amplified in audio amplifier 405 and mixed with RF carrier frequency produced in oscillator 415 controlled by crystal 420. In this technique the SSB signal is produced by filter 430 and transmitted into pre-amplifier with output connected to RF power amplifier 440. Amplified RF signal 450 is transported via transmission line 445 to antenna radiators. Inclusion of band-pass filters is not shown.

### SUMMARY

1) A transmitter system may include a transmission line; an A/D converter for converting a RF signal to a digital signal having a first and second section for transmitting in either electrical or optical form on the transmission line; a preamplifier for amplifying the low power RF signal and being connected to the transmission line to transmit either electrical or optical, delivering a digital signal to converter/receiver mounted on an antenna; a receiver/converter system receiving digital signal for D/A conversion and pre-amplification/amplification and delivering RF signal to an antenna radiator of the antenna. The DC power for antenna circuitry and RF power amplifier is generated in DC power supply located near antenna radiator. However, the DC power may also be delivered to converter box and converted for voltages required by antenna circuitry and RF power amplifier.
   The antenna may be a λ/4 dipole and includes a first antenna radiator and a second antenna radiator

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a conventional transmission station where the transmitter with the power amplifier is located substantial distance from antenna.

FIG. 2 is a transmission station block diagram. An analog signal is converted to the digital form in the converter “A” and then converted back to an analog signal in converter “B”, before it is connected to antenna conductors.

FIG. 3 illustrates a transmission station with a sub-transmitter delivering either an analog or digital signal to an antenna converter located near the antenna radiator.

FIG. 4 illustrates a Prior Art transmitter station diagram where the signal to be generated is processed and connected to the transmission line.

FIG. 5 is a block diagram of a transmitter where the analog signal is digitized and delivered to the antenna converter via the transmission line.

FIG. 6 is a block diagram of a transmitter where the analog RF signal is converted to the digital form and furthermore converted to a digital optical signal delivered via the optical cable to the antenna converter.

FIG. 7 is a block diagram of a transmitter where the digital optical signal is converted to a secondary RF transmitter with a different frequency which delivers the RF signal, analog or digital, to the antenna converter.

FIG. 8 is a block diagram of a receiver and the RF amplifier of the analog RF signal which delivers the amplified signal directly to the antenna radiators. The RF amplifier shown as connecting the amplifier to the antenna conductors including two complementary (positive and negative) RF power amplifiers.

FIG. 9 is a block diagram of a signal receiver and the amplifier. The digital signal is amplified and converted to the analog form in the D/A converter which is further pre-amplified, amplified to a desired power and transported directly to antenna radiators.

FIG. 10 is a block diagram of a receiver accepting the optical digital signal, converting it to the analog signal in a D/A converter and then the signal is amplified and transported directly to the antenna radiators.

FIG. 11 is a block diagram of an RF receiver which first amplifies the signal before converting it to the analog format in a D/A converter. The signal is then pre-amplified and delivered to the final RF amplifier which is connected directly to the antenna conductors.

FIG. 12 is a block diagram of a receiver/transmitter in which the digital signal is pre-amplified, converted to the analog signal in the D/A converter. The signal is then preamplified, delivered to the RF amplifier which is connected via inductive elements to the antenna radiators.

FIG. 13 is a block diagram of a signal receiver/transmitter almost identical to circuit outlined in FIG. 12. After the RF amplification, the power signal is applied to the antenna radiators via capacitors.

FIG. 14 is a block diagram of a signal receiver/transmitter almost identical to circuit outlined in FIG. 13. After amplification, the output power amplifier elements (transistors or tubes) are directly connected to the antenna radiators.

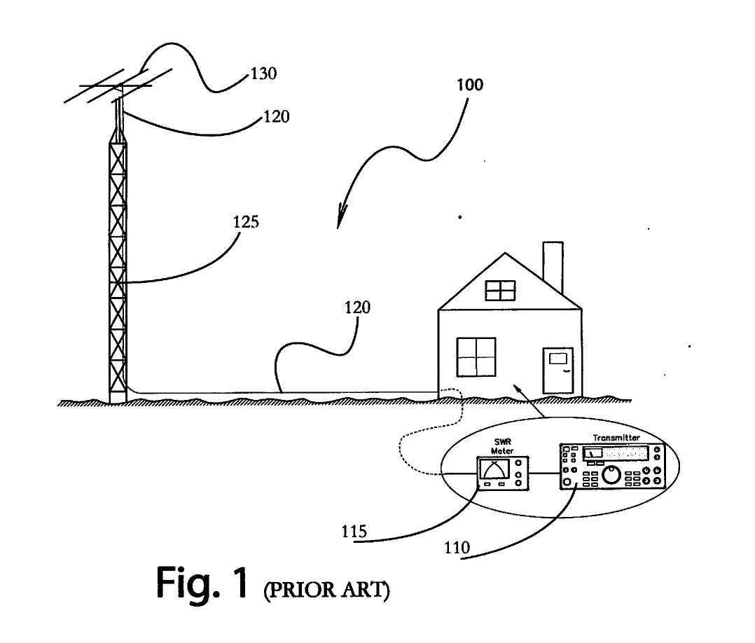

### DETAILED DESCRIPTION

The present invention includes five aspects, either of which may be used alone to improve performance of a RF transmitter. However, the five aspects of the invention are preferably used together to provide a superbly performing transmitting function. The disclosed aspects of the embodiments can also be used alone or in various combinations and sub-combinations with one another.

The first aspect of the present invention is the elimination of conventional energy transporting mechanism, i.e. high power transmission line, carrying RF energy from RF power amplifier to the antenna, located a substantial distance from power amplifier.

It is another aspect of the present invention to connect the RF power amplifier directly to the antenna radiating elements thus minimizing the large levels of distortion, losses and harmonic frequencies.

In another embodiment, signal conversion is from the analog to digital format. The conversion occurs after the balanced modulator output is pre-amplified.

The fourth aspect of the present invention is the conversion of the digitized signal into the digital optical signal, suitable for transportation of the digital signal over a longer distance. The transported optical digital signal has superior properties to the electrical digital signal.

The fifth embodiment of the present invention involves the location of power supply which provides voltages to the RF power amplifier and the supporting electronics. Either AC or DC power may be supplied from the base station.

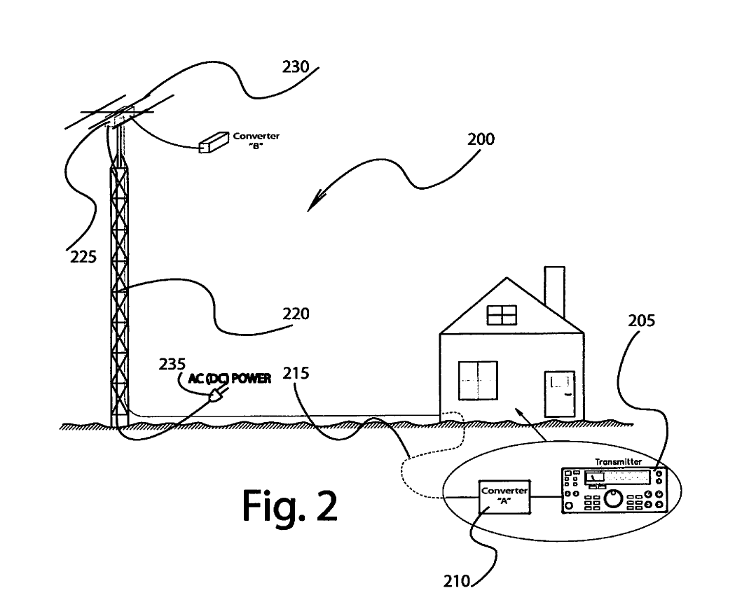

FIG. 2 shows the system diagram of a transmitter station 200, which comprises a transmitter 205, converter “A” 210, a low power transmission line 215 connected to the transmitter 205, an antenna supporting tower 220, receiving converter “B” 225 mounted on the tower 220 and an antenna 230 mounted on the tower 220 and directly connected to the converter 225. Converter “A” 210 supplies analog or digital signal to receiving converter “B” 225 through the low power transmission line 215 where it is amplified or if the incoming signal is a digital format, it converts it to an analog signal before amplification and transmission to antenna 230. The power to converter “B” is delivered via power line 235.

FIG. 3 shows system diagram 300 of a transmitter 305 in which the RF signal transmitted to the antenna is achieved via auxiliary transmitter 310 which transmits a signal from the transmitter antenna with auxiliary transmitter antenna 315. The RF signal frequency of the auxiliary transmitter 310 is substantially different than operating frequency of the transmitter 305. The RF signal is received by the “RF receiver & converter” 325 elevated by the transmitter tower 320 and located near the antenna 330 or the converter may be substantially at the top of the transmission tower. The auxiliary RF signal may be either analog or digital. The power for converter is delivered via power line 335.

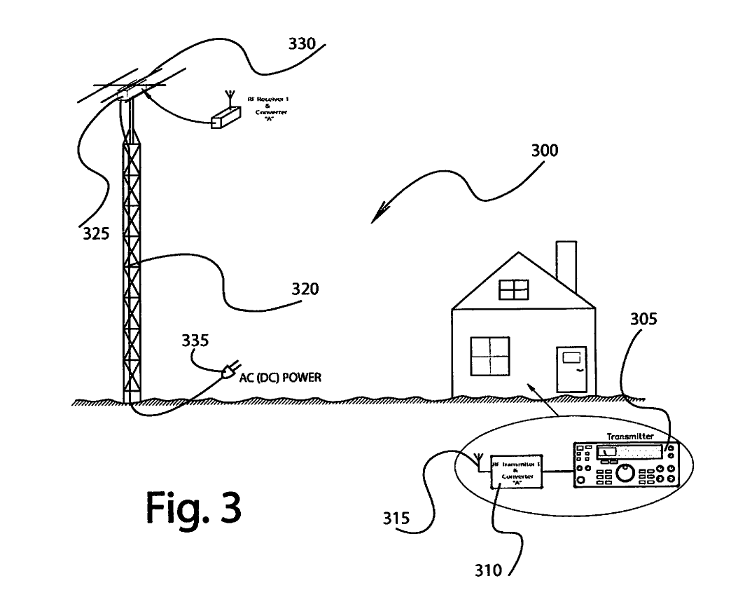

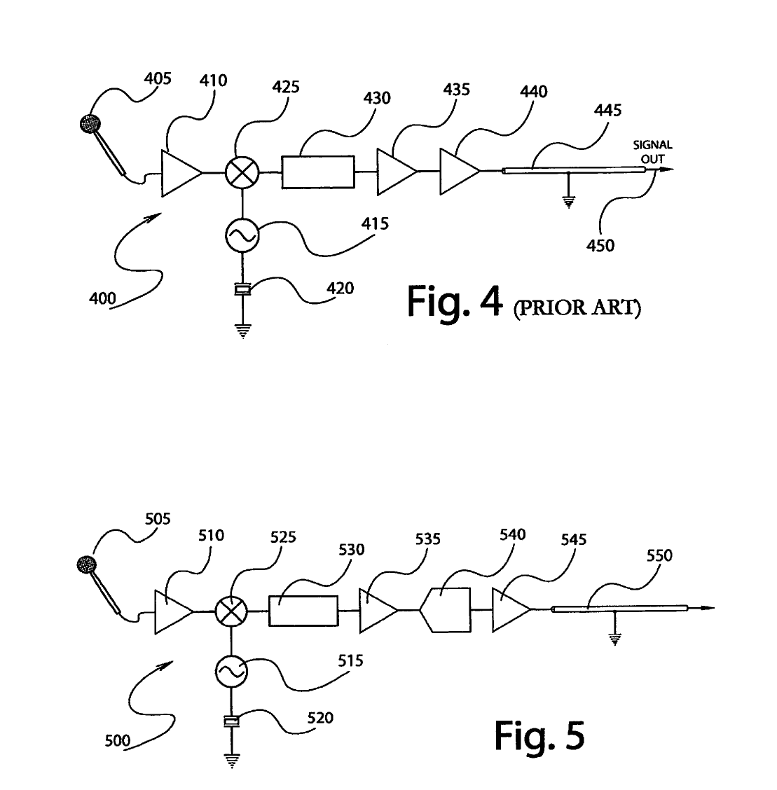

FIG. 4 shows the first version of a transmitter 400 where the RF signal from oscillator 415 controlled with crystal 420 is mixed in balanced mixer 425 with audio signal from audio source 405 and preamplified in preamplifier 410. The mixed signal is processed in filter 430 and a generated SSB signal is preamplified in preamplifier 435 and amplified in amplifier 440. Amplified signal 450 is transported by the transmission line 445 to antenna converter 225.

FIG. 5 shows the second version of a transmitter 500 where the linear signal is converted into digital format. The audio signal from the generator 505 is amplified in the amplifier 510 and mixed with the RF signal in the balanced modulator 525. The RF signal is generated in the oscillator 515 which is crystal 520 controlled. The SSB signal is generated in the SSB filter 530, pre-amplified in the amplifier 535 which is connected to the A/D converter 540. The generated digital signal is transmitted into the amplifier 545, and the digital signal 555 is transmitted via transmission line 550 to the signal converter located near antenna.

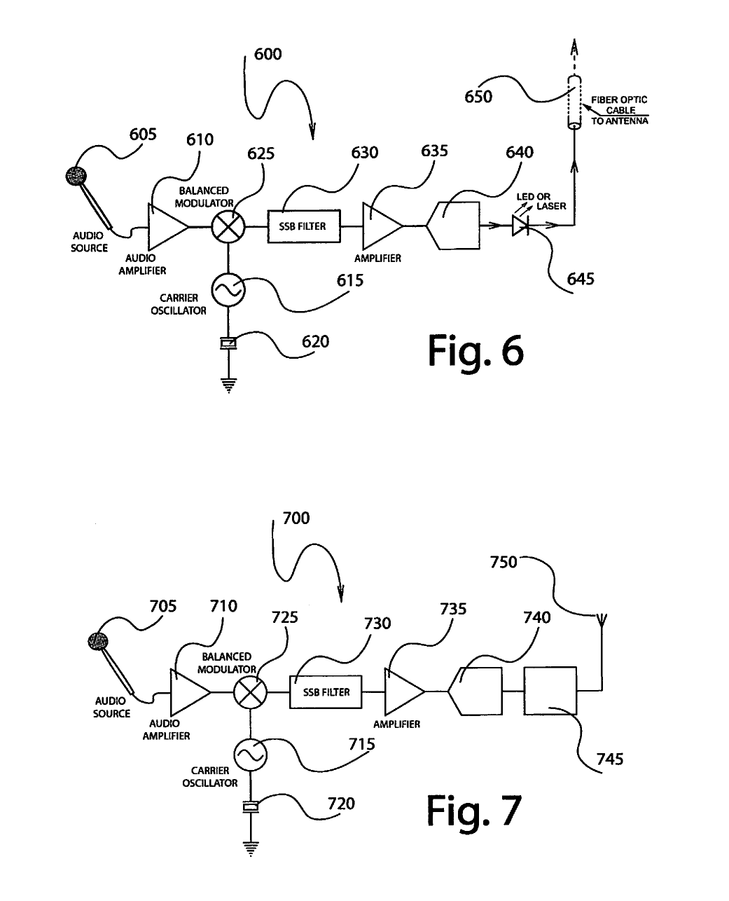

FIG. 6 shows a signal generator 600 where the linear signal is generated in the device 605, transmitted to the audio pre-amplifier 610 and mixed by the audio mixer 625 with the RF signal from the oscillator 615 whose signal is controlled with a precision crystal 620. The next signal output from the mixer 625 with sideband frequencies is transmitted into the SSB filter 630, and the outgoing SSB signal is pre-amplified in preamplifier 635 and transmitted into the A/D converter 640. The generated digital signal is further converted in 645 to the optical signal 655 which is transmitted to the antenna system via the fiber optic cable 650.

FIG. 7 shows the signal generator 700 with the auxiliary transmitter 745. The analog audio signal generator 705 generates the signal which after amplification in the amplifier device 710 is mixed with the RF signal generated by the oscillator 715 having a frequency of which is controlled by the crystal 720. The mixed signal from balanced modulator 725 is transmitted to the SSB filter 730 to remove (by numerous methods) the one sideband frequency, and the remaining signal is pre-amplified in the preamplifier device 735 and transmitted to the A/D converter 740. The signal from A/D converter is transmitted to the auxiliary transmitter 745 and transmitted into the antenna 750 to initiate signal for reception by the receiver 325 located near the transmitter antenna.

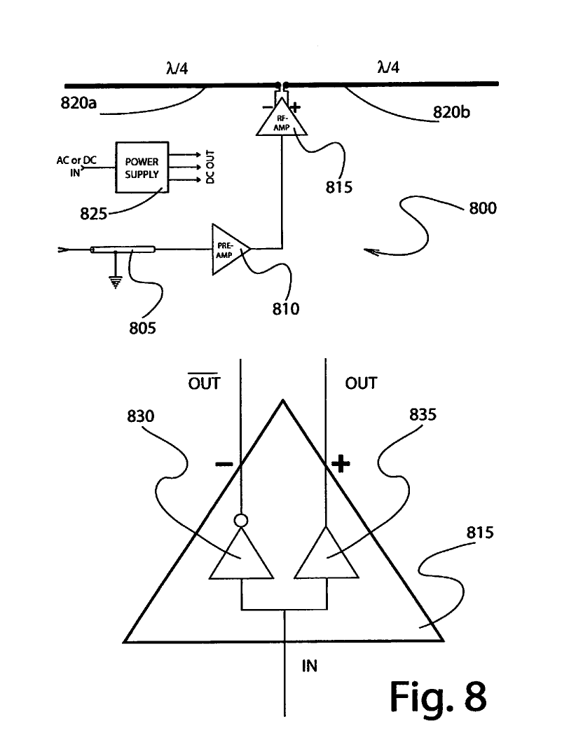

FIG. 8 shows the first RF signal receiver 800 (a single) of the receiver and converter 225 in FIG. 2 in the series of several or multiple RF signal receivers 800. The incoming analog signal transmitted by the transmission line 805 is pre-amplified in preamplifier 810, amplified in RF power amplifier 815 and transported to the dipole antenna conductors 820a and 820b. The length of each of the dipole antenna arms is λ/4. The amplifier 815 includes two complimentary amplifiers 830 and 835. This block diagram arrangement as illustrated in FIG. 8 is presented in many embodiments of the instant application. The power supply 825 is delivering DC power to the receiver circuitries.

A power supply located near antenna and antenna radiators provides power to the final RF amplifier and the associated circuitry. The power supply includes a DC or AC power line with power from the power source near ground and converting the incoming power to require power levels for RF amplification in solid state or tube final stage. Similar circuits are shown in the figures below.

The RF power amplifier may be either a solid state or a tube amplifier and is directly connected to the antenna conductive radiator or the radiators;

The RF power amplifier either solid state or with the power tubes transmits RF energy directly to the antenna radiator/s via a coupling transformer; The RF power amplifier either solid state or with power tubes transmits the RF energy directly to antenna radiator/s via capacitors. The electrical energy transmitted to each traveling wave antenna radiator is accomplished by two independent complimentary RF power amplifiers connected at the opposite ends of the antenna radiators.

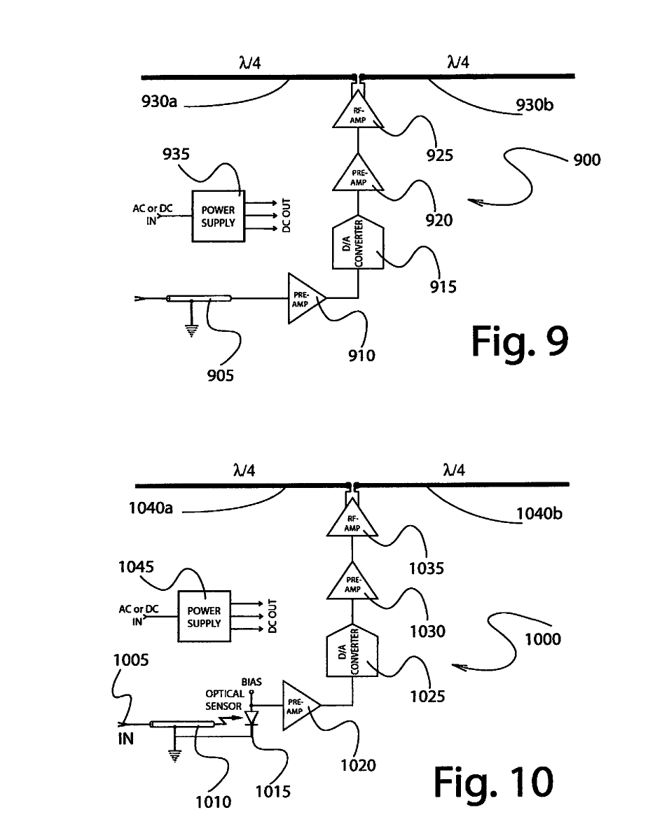

FIG. 9 shows a converter 900 of the receiver and transmitter 225 in FIG. 2 located near the antenna 930. Transmission line 905 transmits a digital signal which is pre-amplified in the preamplifier device 910, transmitted to the D/A converter 915 and outgoing linear signal from the converter 915 is pre-amplified in the preamplifier 920, amplified in the RF power amplifier 925 and transmitted to the first and second antenna radiators 930a and 930b. The antenna is a λ/4 dipole. The power supply 935 is delivering DC power to transmitter circuitries.

FIG. 10 shows a converter 1000 (as illustrated in FIG. 2) where the incoming signal is optical. The signal 1005 is transmitted via the fiber-optic cable 1010, received and converted to a digital electrical signal in the optical sensor 1015. The relatively weak signal is pre-amplified in the preamplifier 1020, converted to analog signal in the D/A converter 1025, pre amplified in the preamplifier 1030 and finally amplified in the RF power amplifier 1035 connected directly to the first and second λ/4 dipole antenna 1040a and 1040b. The power supply 1045 is delivering DC power to the converter circuitries.

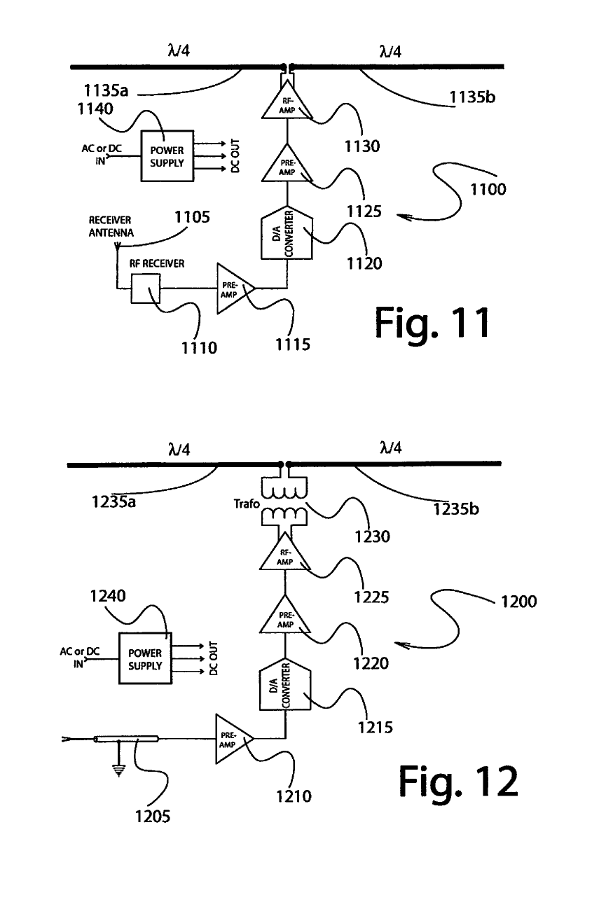

FIG. 11 shows a converter/receiver 1100 as illustrated in FIG. 3 where the incoming signal, whether analog or digital, is transmitted via the auxiliary RF signal. The incoming signal is first received by the antenna 1105 connected to the receiver 1110 with the output being connected and the signal is pre-amplified in the amplifier 1115 and transmitted into the D/A converter 1120 which outputs an analog signal which is pre-amplified in the preamplifier 1125 and amplified in the RF final amplifier 1130. The output from the RF amplifier is directly connected to the antenna conductors, in this case to a λ/4 resonant dipole antenna with the first branch 1135a and the second branch 1135b. The power supply 1140 is delivering DC power to the receiver/transmitter circuitries.

FIG. 12 shows a converter/receiver 1200 as illustrated in FIG. 2 having an analog input signal transported via transmission line 1205 to the pre-amplifier 1210 which is connected to the D/A converter 1215 with analog output connected to preamplifier 1220 and the second RF power amplifier 1225 which is connected to the branches of λ/4 wave resonant dipole antenna having a first branch 1235a and a second branch 1235b. The signal transfer from RF amplifier 1225 to the antenna is attained via transformer 1230. The power supply 1240 is delivering DC power to the receiver/transmitter circuitries.

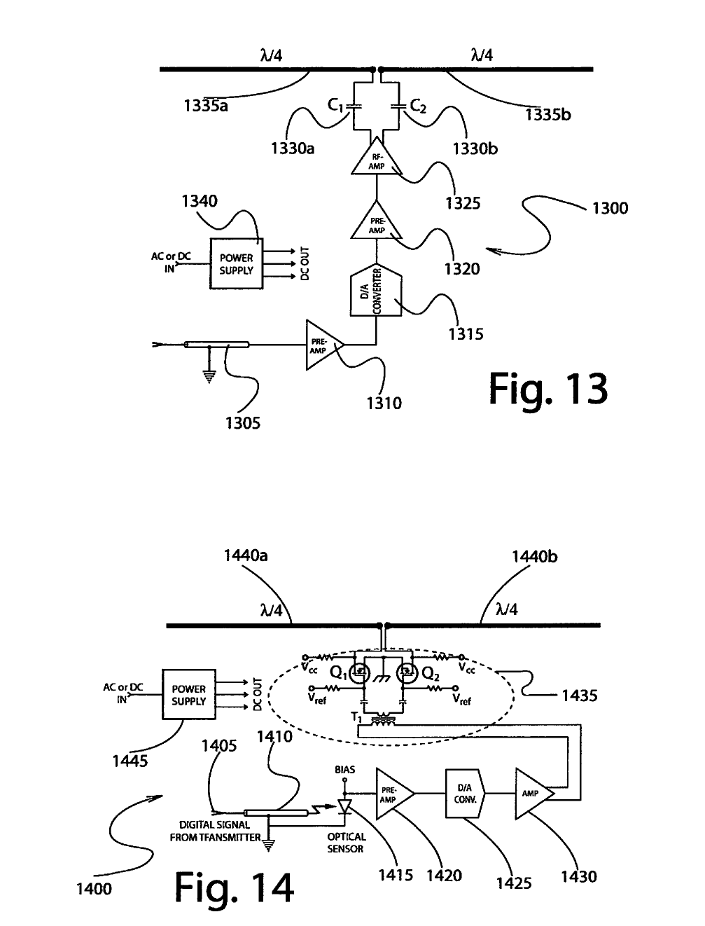

FIG. 13 shows a converter/transmitter 1300 as illustrated in FIG. 2 having digital signal input transported via the transmission line 1305 to the digital pre-amplifier 1310 with signal pre amplified and transferred to D/A converter 1315. The analog signal is then pre amplified in preamplifier 1320 and amplified in RF amplifier 1325. The outputs from RF amplifier are connected to antenna via capacitors (first and second) 1330a and 1330b. The capacitors are directly connected to antenna radiators 1335a and 1335b which are λ/4 long. The power supply 1340 is delivering DC power to the receiver/transmitter circuitries.

FIG. 14 shows a converter/transmitter 1400 as illustrated in FIG. 2 having an analog RF signal transmitted to a signal input 1405 connected via the transmission line 1410 to the optical to electrical converting device 1415 which transmits the output signal to RF power preamplifier 1420 with output connected to the first RF amplifier 1430 with outputs connected via transformer T₁ to a pair of RF power transistors Q₁ and Q₂ (first and second) parallel connected directly to antenna radiators 1440a and a second branch 1440b. The power supply 1445 is delivering DC power to the receiver/transmitter circuitries.

A transmitter system for a wireless communication may include a low power analog transmitter driver located significant distance from power amplifier; and a circuitry for multiplication, filtering, amplification and impedance adjustments for signal transport via transmission line.

The analog signal is converted to digital format in A/D converter.

The analog signal is converted first to digital format in A/D converter and then converted from digital electrical signal to optical digital format.

The analog or digital format signals are converted to a secondary RF signal of different frequency delivering information to RF signal receptor/amplifier distant from said low power transmitter.

The transmitter system for a wireless communication may include a circuitry accepting low power analog RF signal from transmission line; a circuitry for amplification of received RF analog signal; a circuitry adjusting output impedance of RF amplifier for levels compatible with antenna impedance levels; a circuitry delivering high power RF signal directly to antenna radiator/radiators without transmission lines.

A receiver part of a system located significant distance from said transmitters may include a circuitry detecting a low level incoming analog signal from transmission line; a circuitry amplifying incoming signal to desired level for amplification; a circuitry significantly amplifying incoming RF signal; a circuitry adjusting amplified signal levels and providing complimentary outputs if desired; a circuitry providing RF signal for delivery to antenna radiators at required impedance levels.

The incoming signal is digital including a preamplifier circuitry cleaning low level incoming digital signal; a circuitry providing D/A conversion and delivering analog signal for pre amplification; a circuitry significantly amplifying analog signal and providing complimentary RF signal; circuitry applying amplified RF signal to antenna radiator/radiators in complimentary form.

The incoming signal on the optical transmission line is optical; a circuitry converting incoming digital optical signal to electrical signal; a circuitry providing digital to analog conversion (D/A) a circuitry pre amplifying low level analog signal; a circuitry providing final power amplifier function; a circuitry providing RF complimentary outputs when required.

A converter (receiver/transmitter) system may include a signal pre amplifying and “cleaning” device; a digital signal from pre amplifier converted to analog signal in D/A converter; a signal from converter fed into analog preamplifier; a signal from pre amplifier fed into final power amplifying (PA) RF stage; a signal from final amplifier (PA) connected directly to antenna conductor/conductors.

The complimentary outputs from RF power amplifier are connected to inductive element; a transforming element is directly connected to antenna radiator/radiators.

The complimentary outputs from RF power amplifiers are connected to capacitors; and a direct connection to antenna conductors is via capacitors.

The complimentary outputs from linear preamplifier are inductively coupled to radio frequency power amplifier consisting of discrete elements; and a conductor/conductors of active device/devices are directly and resistively coupled to antenna radiators.

Thus, while the present invention has been described with respect to a specific preferred embodiment, numerous modifications will suggest themselves to those of ordinary skills in the art, for example, antennas of types other than those discussed may be used to wireless transport high power electromotive energy for utilitarian purposes such as delivery of electricity to homes.

1. A transmitter system, comprising:
a transmission line for transmitting a low power RF signal;
a first preamplifier for amplifying the low power RF signal and being connected to the transmission line;
an D/A converter for converting a RF signal to an analog signal;
a second preamplifier for amplifying the output of the D/A converter;
a amplifier connected to the second preamplifier and directly connected to the antenna.

2. A transmitter system as in claim 1, wherein the antenna is a λ/4 dipole and includes a first antenna radiator and a second antenna radiator

3. A transmitter system as in claim 1, wherein the amplifier includes a first output and a second output, each being directly connected to the first antenna radiator and the second antenna radiator respectively.

4. A transmitter system as in claim 1, wherein the amplifier includes a first output and a second output, each being directly connected to the antenna is a first and second λ/4 dipole antenna.

5. A transmitter system as in claim 1, wherein the digital signal is an optical signal.

6. A transmitter system as in claim 1, wherein the amplifier includes a first output and a second output, each being directly connected to a first capacitor and a second capacitor respectively and the first and second capacitor being directly connected the first antenna radiator and the second antenna radiator respectively.

7. A transmitter system as in claim 1, wherein the amplifier includes a first output and a second output, each being directly connected to a first transistor and a second transistor respectively and the first and second transistors being directly connected the first antenna radiator and the second antenna radiator respectively.
